(19) United States
(12) Patent Application Publication
(10) Pub. No.: US 2017/0364794 A1
(43) Pub. Date: Dec. 21, 2017

(54) METHOD FOR CLASSIFYING THE PAYLOAD OF ENCRYPTED TRAFFIC FLOWS

(71) Applicant: Telefonaktiebolaget LM Ericsson (publ), Stockholm (SE)

(72) Inventors: Heikki MAHKONEN, San Jose, CA (US); Ravi MANGHIRMALANI, Fremont, CA (US); Miguel Angel MUNOZ DE LA TORRE ALONSO, Madrid (ES); Veronica SANCHEZ VEGA, Madrid (ES); Meral SHIRAZIPOUR, San Jose, CA (US)

(21) Appl. No.: 15/187,685

(22) Filed: Jun. 20, 2016

(51) Int. Cl. G06N 3/08; H04L 12/26; H04L 29/06

(52) U.S. Cl. CPC G06N 3/08; H04L 63/1425; H04L 43/10; H04L 63/0428

(57) ABSTRACT

A method is implemented by a network device to classify encrypted data traffic. The method identifies characteristics of the encrypted data traffic that have been modeled where network anomalies have been injected into the encrypted data traffic to provide additional traffic characteristics that enable categorization. The method receives the encrypted data traffic, applies an encrypted traffic categorization model to the received encrypted data traffic to determine a first categorization identification, injects an anomaly into the encrypted data traffic where the first categorization identification is not within a precision threshold, applies the encrypted traffic categorization model to monitored encrypted traffic after injection of the anomaly to determine a second categorization identification, and applies the second categorization identification where the second categorization identification is within the precision threshold.

### TECHNICAL FIELD

Embodiments of the invention relate to the field of traffic classification; and more specifically, to a method and apparatus for classifying traffic that has been encrypted.

### BACKGROUND

Encryption is utilized to protect the content of data traffic as it traverses a wide area network, such as the Internet. Where encryption is performed at the endpoints of communication, i.e., the user device originating the data traffic and the destination device that receives the data traffic, intermediate devices have only minimum information about the data traffic that traverses them, usually little more than the destination address for a data packet, i.e., the payloads of the data packets are typically encrypted. The amount of such encrypted traffic is increasing due to increases in security concerns and ease at which robust encryption can be implemented at endpoint devices.

However, currently, intermediate devices often perform some level of packet inspection, i.e., examining the content of data packets received at an intermediate device, to facilitate efficient data traffic handling such as implementing quality of service processes and similar processes that can prioritize data traffic based on the type or classification of the data traffic (e.g., video streams, email, voice over Internet protocol). High levels of encrypted traffic can cause an issue for traffic management schemes that rely on traffic classification information. This is because most of the traffic classification schemes (e.g., Deep Packet Inspection (DPI)) rely on payload inspection to classify the traffic.

DPI is a technology used to inspect packets sent over the network by examining both the headers, referred to as shallow packet inspection (SPI), and payload (e.g. layer 7 information). DPI is used in real time to identify and analyze traffic flows based on their application type, content type, and other measurable parameters. More generally, traffic classification relies on seeing the payload of the packets. Therefore, payload encryption renders most of existing classification mechanisms inefficient at the least and completely ineffective in the worst case. SPI may still be possible but is limited. Thus, with the increase in encrypted traffic the efficiency of handling this information and the data traffic flows is diminished leading to overall traffic management performance degradation in the networks carrying the encrypted data traffic.

### SUMMARY

The embodiments include a method implemented by a network device to classify encrypted data traffic. The method identifies characteristics of the encrypted data traffic that have been modeled where network anomalies have been injected into the encrypted data traffic to provide additional traffic characteristics that enable categorization. The method includes receiving the encrypted data traffic, applying an encrypted traffic categorization model to the received encrypted traffic to determine a first categorization identification, and injecting an anomaly into the encrypted data traffic where the first categorization identification is not within a precision threshold. The method then applies the encrypted traffic categorization model to monitored encrypted traffic after injection of the anomaly to determine a second categorization identification, and applies the second categorization identification where the second categorization identification is within the precision threshold.

In a further embodiment a network device is configured to execute the method to classify encrypted data traffic. The network device includes a non-transitory computer-readable storage medium having stored therein an encrypted traffic categorizer, and a processor coupled to the non-transitory computer-readable storage medium. The processor is configured to execute the encrypted traffic categorizer. The encrypted traffic categorizer receives the encrypted data traffic, applies an encrypted traffic categorization model to the received encrypted traffic to determine a first categorization identification, injects an anomaly into the encrypted data traffic where the first categorization identification is not within a precision threshold, applies the encrypted traffic categorization model to monitored encrypted traffic after injection of the anomaly to determine a second categorization identification, and applies the second categorization identification where the second categorization identification is within the precision threshold.

In one embodiment, a computing device executes a plurality of virtual machines for implementing network function virtualization (NFV), wherein a virtual machine from the plurality of virtual machines is configured to execute the method to classify encrypted data traffic. The computing device including a non-transitory computer-readable storage medium having stored therein an encrypted traffic categorizer, and a processor coupled to the non-transitory computer-readable storage medium. The processor is configured to execute one of the plurality of virtual machines. The virtual machine executes the encrypted traffic categorizer. The encrypted traffic categorizer receives the encrypted data traffic, applies an encrypted traffic categorization model to the received encrypted traffic to determine a first categorization identification, injects an anomaly into the encrypted data traffic where the first categorization identification is not within a precision threshold, applies the encrypted traffic categorization model to monitored encrypted traffic after injection of the anomaly to determine a second categorization identification, and applies the second categorization identification where the second categorization identification is within the precision threshold.

In a further embodiment, a control plane device is configured to implement at least one centralized control plane for a software defined network (SDN). The centralized control plane is configured to execute the method to classify encrypted data traffic. The control plane device includes a non-transitory computer-readable storage medium having stored therein an encrypted traffic categorizer, and a processor coupled to the non-transitory computer-readable storage medium. The processor is configured to execute the encrypted traffic categorizer. The encrypted traffic categorizer receives the encrypted data traffic, applies an encrypted traffic categorization model to the received encrypted traffic to determine a first categorization identification, injects an anomaly into the encrypted data traffic where the first categorization identification is not within a precision threshold, applies the encrypted traffic categorization model to monitored encrypted traffic after injection of the anomaly to determine a second categorization identification, and applies the second categorization identification where the second categorization identification is within the precision threshold.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of a network over which encrypted data traffic is transmitted.

FIG. 2 is a diagram of one embodiment of a process for implementing and updating encrypted data traffic categorization.

FIG. 3 is a diagram of one embodiment of a process for updating an encrypted data traffic categorization model.

FIG. 4 is a flowchart of one embodiment of the process for updating the encrypted data traffic categorization model.

FIG. 5 is a diagram of one embodiment of a process for encrypted data traffic categorization.

FIG. 6 is a flowchart of one embodiment of the process for encrypted data traffic categorization.

FIG. 7A illustrates connectivity between network devices (NDs) within an exemplary network, as well as three exemplary implementations of the NDs, according to some embodiments of the invention.

FIG. 7B illustrates an exemplary way to implement a special-purpose network device according to some embodiments of the invention.

FIG. 7C illustrates various exemplary ways in which virtual network elements (VNEs) may be coupled according to some embodiments of the invention.

FIG. 7D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 7E illustrates the simple case of where each of the NDs implements a single NE, but a centralized control plane has abstracted multiple of the NEs in different NDs into (to represent) a single NE in one of the virtual network(s), according to some embodiments of the invention.

FIG. 7F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 8 illustrates a general purpose control plane device with centralized control plane (CCP) software 850), according to some embodiments of the invention.

### DETAILED DESCRIPTION

The following description describes methods and apparatus for encrypted data traffic categorization to improve the handling of encrypted data traffic over a network by intermediate devices where the encryption is end-to-end encryption. The online process models the visible characteristics of known data traffic types and compares the visible characteristics of the incoming encrypted data traffic to a categorization model. To improve the accuracy of the categorization, the training system can inject anomalies into the encrypted data traffic and monitor the resulting encrypted data traffic flow characteristics and utilize these additional characteristics and the encrypted data traffic categorization models in the training system to determine the category of the encrypted traffic. This information is then used to update the categorization models in the online process when the latter is unable to categorize the encrypted data traffic accurately. The training system may generate encrypted data traffic categorization models offline by a process that injects anomalies into known data traffic and the encrypted data traffic and monitors the resulting characteristics of the encrypted data traffic flow before and after anomaly injection.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Overview

As discussed herein above, the increasing amount of encrypted data traffic causes an issue for traffic management schemes that rely on traffic classification information. Traffic classification schemes rely on information in the payload of data packets. When the data packets are encrypted this information is not available. Technologies that rely on payload information for data packets are often referred to as Deep Packet Inspection (DPI)) technologies, whereas technologies that only rely on header information are referred to as shallow packet inspection (SPI).

DPI is a technology used to inspect packets sent over the network by examining both the headers via SPI and payload information (e.g., layer 7 information). DPI is used in real time to identify and analyze unencrypted data traffic flows based on their application type, content type, and other measurable parameters. Payload encryption renders most of the existing classification mechanisms inefficient as they are based on DPI. SPI may still be possible to utilize for data packet classification, but the information available is limited.

The telecommunication industry and research community have an interest in solving this problem and finding a process whereby packet classification and the associated services and traffic management processes can be utilized with encrypted data traffic. Traffic management includes enforcements of the type called content-aware actions that do not work over encrypted traffic as they are realized today. Examples are video optimization or caching, redirect or parental control. For these enforcements, either network operators get access to the ‘clear’ unencrypted data traffic, which in many cases is not feasible, or these enforcements must be “reinvented.” The embodiments provide an alternative that enables relatively accurate encrypted data traffic categorization. The process relies on identifying characteristics of various types of data traffic that are unaffected by encryption such that data traffic that exhibits these characteristics can be reasonably expected to reliably identify respective encrypted data flow content type. In some embodiments, these content-aware enforcements are mostly, but not completely implemented in non-evolved packet core (EPC) products and with other embodiments the process may be adapted for other collaboration forms, for example, with content delivery networks (CDNs).

The telecommunication industry and researchers are exploring a wide variety of initiatives to address this problem that revolve around collaboration (i.e., collaboration between the network operators, network providers or user equipment manufacturers). This issue is one of the trends related to encryption and not only a challenge but an opportunity for network operators to add value. There are several possible routes for addressing the issue including offline and also online collaboration based on the definition of a number of application programming interfaces (APIs) addressing different types of use cases (UCs). The APIs can address getting assistance for service differentiation related to sponsored data, zero rating, and similar conditions. There is also another possible method for exchanging keys, or use digital certificate inspection to allow the network operator to access the content (or parts of it). This allows service aware content-aware actions. At the moment, these possible approaches seem difficult to argue and justify, and are likely to encounter public opposition and so these approaches are very unlikely to succeed.

Many network management and value added features that could be impacted by encryption, in particular end-to-end (e2e) encryption, are not yet commonly deployed, i.e. the problems with full e2e encryption are yet to be widely seen in networks. For many of the currently deployed features that could be impacted by encryption, there are varying levels of impairment from minimal impairment to complete impairment. Services that rely on DPI are significantly impacted.

The Internet Engineering Task Force (IETF) may review current third generation partnership project (3GPP) architectural use of content-based classification for radio resource allocation and may discuss potential solutions to the classification of encrypted traffic such as zero-bit active queue management (AQM) alternative, 1-bit alternative signal, modern differentiated services code point (DSCP marking). Having end-point over the tops (OTTs) expose classification of their payload may not be fully viable as end point applications could have various incentives to misguide the network. Similar problems have been seen with SPI mechanisms that for example used knowledge of transport control protocol (TCP)/user datagram (UDP) ports to identify an application. Therefore, any solution relying on end-points (OTTs) to send classification information should also have means to verify that information, the embodiments could be applied to assist in such verification.

Traffic classification has also been studied in academic work and some of this work either does not rely on payload data or is designed to circumvent the problem caused by encryption. Below some of this work is discussed, however, none of these techniques are used in production as most of them rely on changes in current network architecture or in current applications, which makes their adoption non-trivial. The embodiments offer an alternative to these techniques which is more easily implemented in existing architectures, but which can be used in combination with some of these techniques.

Machine learning (e.g., via use of or in combination with fingerprinting) is one such technique. Machine learning (ML) can use decision trees to identify data packets by their size distribution, TCP window sizes, TCP flag bits, packet directions from IP packet headers and similar information to classify unencrypted or encrypted data traffic. Other possible solutions posit that data traffic categorization either allow for middlebox DPI functionality or payload encryption, but the processes cannot accommodate both. To address this, the processes provide a new encryption algorithm which allows keeping the encryption on the payload but also allows middleboxes to carry out their DPI functionalities. The approach is for the DPI to perform the inspection directly on the encrypted traffic. The processes propose a new searchable encryption scheme and the detection algorithm which allows for fast packet inspection. Some processes have been based on secure socket layer (SSL) interception to proxy and decrypt the traffic at the middlebox, but these processes have not yet been worked out to be secure. Thus, end users seeking e2e encryption are not likely to be willing to utilize such searchable encryption schemes.

The embodiments overcome the limitations of the prior art. The prior art processes and schemes as set forth above are either unsecure (i.e., they decrypt the traffic at the middleboxes) or cannot classify encrypted data traffic accurately. A certificate inspection method is limited too as different services can share the same certificate. Thus, there is no technique or process in the prior art that is able to validate if information provided by OTTs about the encrypted traffic type is accurate.

The embodiments of the invention overcome these limitations of the prior art. The embodiments provide a process that is able to determine or validate the content information of encrypted traffic flows. The process may utilize quality of service (QoS) management functionality that may be implemented in common network nodes (e.g., traffic management nodes for throttling etc.) to inject for example latency, and/or jitter, and/or packet loss and/or packet shuffling and/or connection (e.g., transport control protocol (TCP)) reset and/or throttling or similar anomaly and then, monitor the reaction of the traffic flow in response to the anomaly. The monitored reaction could consist in numerous changes in the data traffic flow including changes in throughput, packet size, packet inter-arrival time, connection was reset, statistical values of the above, and similar changes to data traffic flow.

The monitored reaction (i.e., monitored traffic characteristics after anomaly injection) is used to determine the traffic type of the encrypted flow. This identification is based on a training a categorization model (e.g., using machine learning such as neural networks or complex multi machine language algorithm systems) and using test traffic to train it to be able to match the encrypted traffic's characteristics to an application type. The encrypted data traffic's characteristics could be based on what is visible in packet headers and measured traffic characteristics before the anomaly injection, the injected anomaly (e.g. latency or similar anomaly) and what is visible in packet headers and the measured characteristics of the encrypted traffic after the injected anomaly. In some embodiments, test traffic may be generated offline by collecting data packets from known applications and transmitting them over a closed or simulated network where the reaction of the data traffic to various network anomalies can be monitored.

Once this training system is created and its models are built, the resulting models can be used by the online system in the following manner. The online system is used to map encrypted traffic's basic characteristics (e.g., the visible characteristics) to an application. If the online system cannot do this mapping within given accuracy limits, it triggers anomaly injection on the encrypted data traffic to be identified and uses the categorization models from the training system to determine the traffic type. This information is used again to update the mapping model of the online system. This utilization of anomalies is for a short period of time on a small portion of the overall data traffic being categorized.

The embodiments provide advantages over the prior art. The embodiments enable the categorization and/or identification of the application type of e2e encrypted traffic, without having to break the encryption, and without requiring any protocol changes (e.g. carrying application info on packet headers which could lead to dishonest marking of packets by end points). In some embodiments, such as the latter case, the embodiments can be used to verify, i.e., detect dishonest end-point markings. The embodiments provide a process that can learn new applications mappings as they are discovered or computed. The embodiments can also be mixed with other techniques to form more accurate traffic classification techniques.

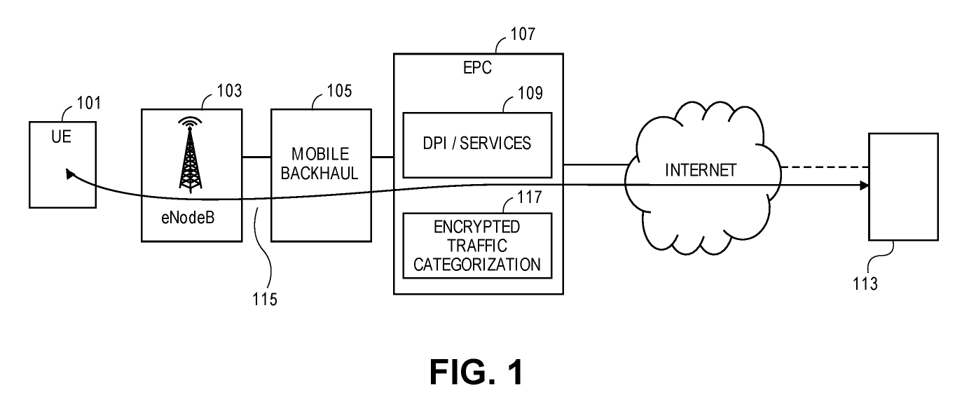

FIG. 1 is a diagram of one example embodiment of a network within which the embodiments can be implemented. The example embodiments, are provided by way of example and not limitation. The network is simplified in its representation to show a path 115 of an encrypted data traffic flow from one end point to another endpoint. In the example embodiment, the first endpoint is a user equipment (UE) 101 that is communicating with another endpoint via a wireless cellular communication system. In other embodiments, the endpoints may both be wired and the encrypted data traffic categorization may be implemented by any network device along the route of the path 113 of the encrypted data traffic flow. Any combination of wired and wireless communication system may be intermediate to the endpoints involved in the encrypted communications.

A UE 101 may be a smartphone, laptop, personal computer, handheld device, console device or similar computing device. The UE 101 can be in communication with another computing device 113 via the network, where the network can be a wide area network, such as the Internet or similar network. The network can include any number of intermediate devices that include network devices of a cellular network or similar network devices. In the example embodiment, the UE 101 is a cellular device such as a smartphone that communicates with the network via a base station such as via an eNodeB 103 of an evolved packet core (EPC) 107 or similar network device. The eNodeB 103 can be in communication with the EPC 107 via a mobile backhaul network 105, which is a set of intermediate network devices between the eNodeB 103 and the EPC 107 including a set of gateway network devices and similar network devices.

Traffic management may be implemented by network devices in the EPC 107. The traffic management can include DPI based services 109 and encrypted traffic categorization services 117. DPI and similar services 109 can be employed to manage services that operate over data traffic that is unencrypted. Whereas, encrypted data traffic has inaccessible payloads that rely on the encrypted traffic categorization services 117 of the embodiments presented herein.

The EPC 107 can connect with a WAN such as the Internet or similar additional set of networking devices that enable the end to end path 115 to reach from the UE 101 to the other endpoint computing device 113. In other embodiments, the other endpoint computing device 113 may be part of the same network including the EPC 107. The end to end (e2e) path 115 is in this example an e2e encrypted data flow that is managed by encryption communication software at each endpoint that renders the payload of the data traffic exchanged by the two endpoints inaccessible to all intermediate network devices thereby making it impossible to utilize DPI to categorize the data traffic and apply traffic management enforcements for the EPC 107 or other aspects of the network.

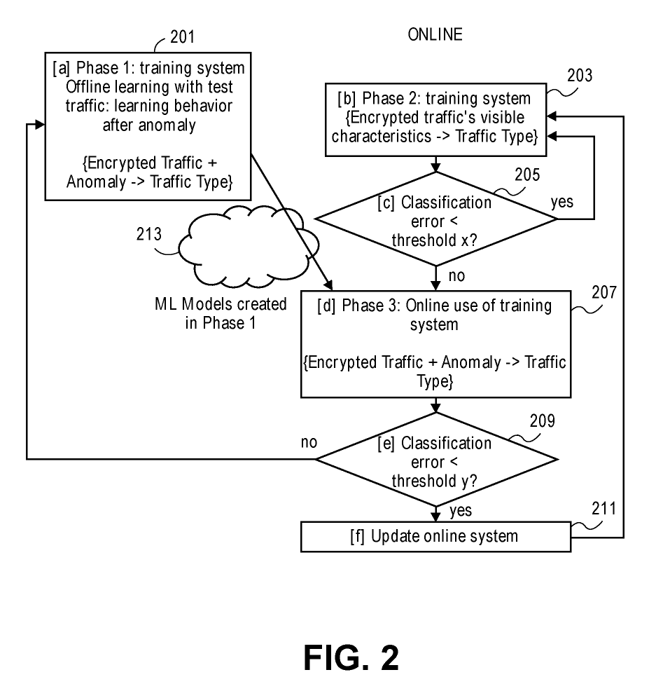

FIG. 2 is a diagram of one embodiment of the process for encrypted data traffic categorization. The embodiments of the process encompass determining the content type of encrypted traffic flows, mostly for the purpose of network traffic management. The determined content type can be used as is, or to validate the extra information carried by the encrypted data traffic flow to identify its type.

The embodiments are described with the example of the use of machine learning (ML), but can be implemented with other techniques as well. The principle and the focus of the embodiments is in the input data set fed into the ‘black box’ system (e.g., a ML based). The embodiments enable the feeding of the encrypted traffic characteristics into an ML system and based on clustering and similar information a determination of its classification. The embodiments augment those techniques and involve generating extra input by first injecting network anomaly on the data traffic flow for a given duration and measuring the end to end behavior of the data traffic flow after the anomaly. This e2e behavior is to differ depending on the application and hence will be a method or means to determine the application type (e.g. VoLTE, Skype, Whatsapp call, Viber call, Netflix Video streaming, Hulu video streaming, Amazon video streaming, web browsing traffic, file download, and similar application data traffic types).

The offline system referred to herein as the training system generates a categorization model that is trained initially with test traffic as shown in Step [a] (Block 201) of FIG. 2. The online system then processes live data traffic (at Step [b]) (Block 203), the online system attempts to classify encrypted data traffic based on basic header information and other visible data. If the error on the online system matching is higher than a given threshold (Step [c]) (Block 205), then the method injects anomalies into the data traffic flow and tries to map the responsive behavior of the data traffic to a given application based on what was learned in Step [a] (i.e. using the training system categorization model). The initial mapping in the online system (e.g., L0-4 header info mapping to application type) could also come from other sources (e.g. operator knowledge) and could be used to configure the online system in Step [b]. However, any data traffic for which this mapping is not available will generate a classification error bigger than the threshold as detected by Step [c] and this will start the process of anomaly injection at Step [d] (Block 207). Which then follows with Step [e] (Block 209) where it is determined whether the training system is able to identify the data traffic type based on post-anomaly behavior (i.e., where the classification error is below a threshold y, if yes, that information is used to update the categorization model utilized by the online system mapping rules (Step [f]) (Block 211). If the online system failed to identify the traffic type using the current categorization model, then the classification error and monitored data flow traffic information needs to be fed back to Step [a] of the training system which, in an offline process, generates test data and uses it to update categorization models.

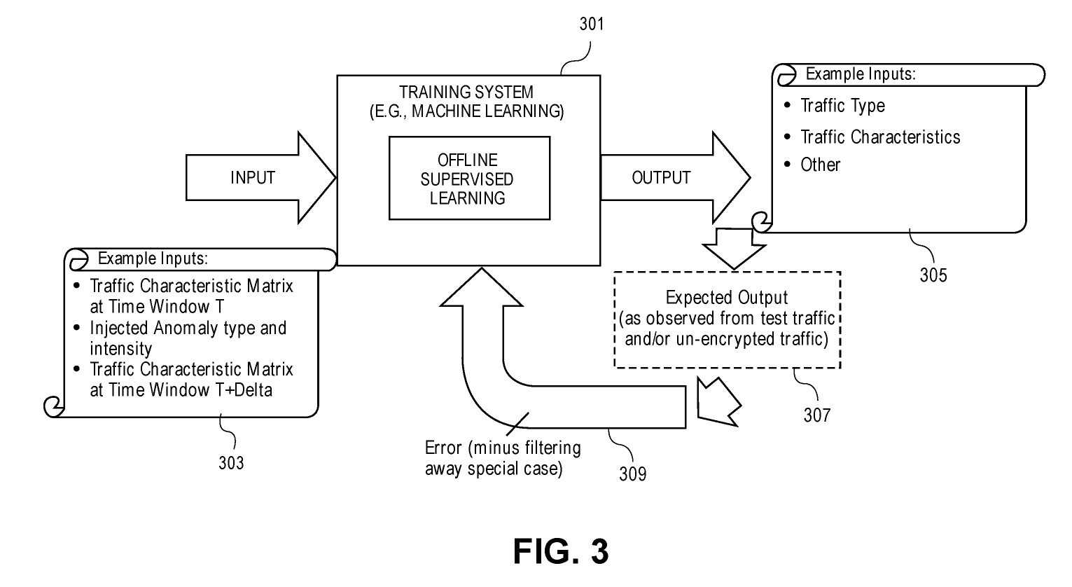

The training system process and the online system processes are broken down and described in further description in relation to FIGS. 3-6.

FIG. 3 is a diagram of one embodiment of the function of the training system. The training system implements or influences the phases [a], [b], and [d] of FIG. 2. The training system can be implemented by use of machine learning (ML) or similar algorithm. The ML system described in FIG. 3 is shown as a black box with input/output examples. The inside of the ML box is discussed with examples but the actual configuration may be configured depending on the traffic type and network setting. One or multiple ML components (clustering algorithm, neural network (NN), decision tree, or similar components.) could be used in parallel, serial or other configurations. Moreover, depending on the complexity of input-to-output matching, even simple non-ML based techniques could be used in the black box system of FIG. 3.

The training system (301) implements the phase [a] described above, where the required steps to implement training of a model are described with relation to FIG. 3, where the initial training occurs offline, before the model is utilized by the online system. The training involves generating test traffic for various known applications types (i.e., that will be expected to be data traffic encrypted at end points such that for traffic management, the intermediate devices seek to identify the category or application type of the encrypted data traffic), then measuring the data traffic characteristics. Subsequently various anomalies are interjected into the data traffic and then the traffic characteristics are again measured. These measured characteristics are used to update and train the categorization model to be provide to the appropriate online systems (Phase[d] 207).

The machine learning implemented by the training system (i.e., the black box view) determines the traffic type and characteristics based on its behavior (i.e. traffic characteristics) before and after network anomaly injection. Inputs (303) into the process include traffic characteristics (e.g., at time windows T and T+ Delta), these traffic characteristics may include L0-L4 header information, throughput measurement, packet size, packet inter-arrival time, whether a connection was reset (e.g., at time T+Delta), and similar characteristics. Delta is the time during which the anomaly is injected and can vary depending on the anomaly type and application type. In some embodiments, for a given anomaly time different Deltas may be tried as different applications may demonstrate a reaction at varying Delta times.

Similarly, the inputs into the training of the model by the black box (e.g., the ML process) for the anomaly injections may include monitored reactions to anyone or more of latency, jitter, packet loss, packet shuffling, connection types (e.g. TCP), throttling (i.e. using active queue management (AQM), e.g. via a leaky bucket algorithm) and similar traffic modifications and monitored characteristics.

The output (305) from the black box process can be an identification or mapping of the input traffic (303) to traffic or application type. The output can more specifically include traffic types such as a voice call (e.g., VoLTE, Skype, Whatsapp call, Viber call), a video call (e.g., FaceTime, Skype, Whatsapp call, Viber call), video streaming (e.g., Netflix, Hulu, Amazon), web browsing traffic (e.g., browser type), file download, or similar application types. The output can also include traffic characteristics information, such as traffic characteristics other than those measurable (application parameters hidden by encryption, and similar information (e.g. accuracy estimate of the mapping, how close it is to data used for training etc.). This output can be a mapping, matrix or similar format that serves as a categorization model to be provided to the online system.

Further, the training system can be fed errors (after filtering special cases, e.g. anomalous traffic that is not to be learned) from the input/output and monitored traffic data (309). The output can be compared or combined with expected output information (307). Known output from unencrypted traffic types or application data can be used to make the mappings of the input and output information to specific traffic and application types. Feedback may be used in embodiments where backpropagation NN type learning processes are employed in the training system. Once a categorization model is used by the online system the feedback about errors in its predictions may be refined.

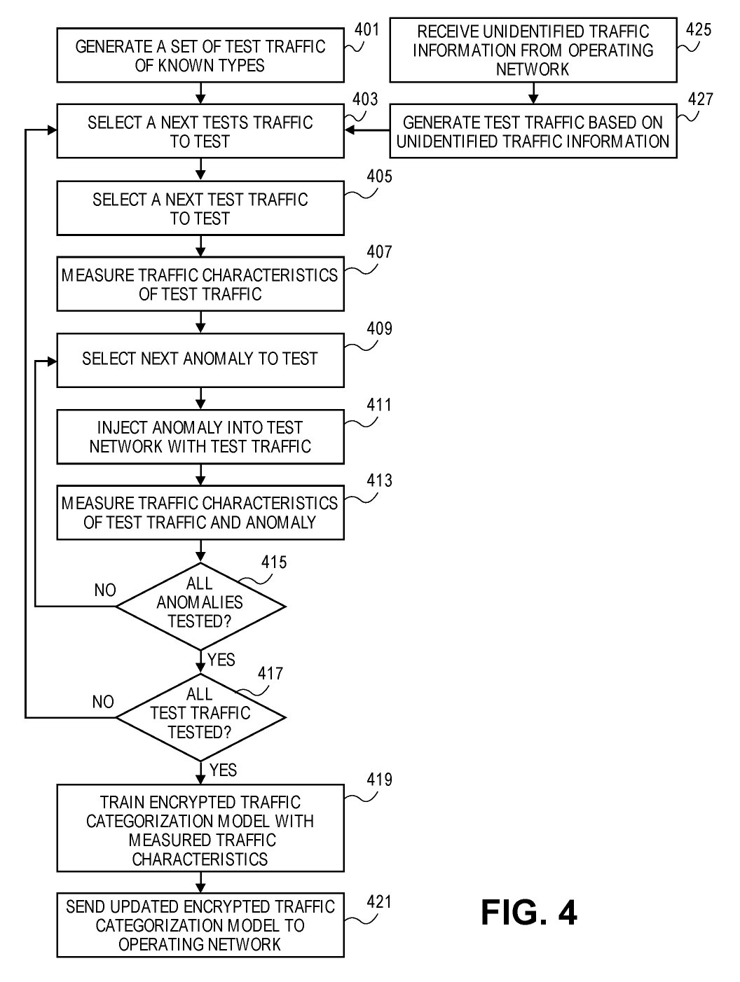

FIG. 4 is a flowchart of one embodiment of a process for the training process. In one embodiment, the process may begin with the generation of a set of test traffic of known traffic types (Block 401). Any number or variety of known application and data traffic types can be generated or simulated. This may be the starting point before the online system has begun operation. In other embodiments, where the online system is already in operation, feedback may be received to identify unknown traffic types observed during operation (Block 425, from step [e] of FIG. 2 returning no). In this case, the test traffic may be generated based on information provided about the unidentified traffic (Block 427).

The process selects one of the sets of test traffic to process (Block 403). The selected test traffic can then be input into a test network, which may be a real controlled test network or a simulated test network (Block 405). The result of injecting the test traffic into the test network is then observed and measured (Block 407). The results can be measured in terms of any type of traffic characteristics as set forth above. The observed traffic characteristics are associated with the traffic or application type. Then the process selects a set of anomalies to test (Block 409). Anomalies can be injected by type one at a time or in any combination into the test network along with the test traffic (Block 411). The anomalies could be of different durations (i.e. same anomaly could be tested for different durations). The process then monitors and measures the traffic characteristics of the data traffic that result from the injected anomaly (Block 413). A check may be made whether all anomalies to be tested have been exhausted (Block 415). If all of the anomalies have not been exhausted, then the process selects the next set of anomalies to test (Block 409). If all of the anomalies have been tested, then a check is made whether all the different traffic types to be tested have been tested (Block 417).

If all traffic types have not been tested, then the next traffic type is selected (Block 403). If all of the traffic types have been tested, then the process records the mapping or correlations as part of the training of the encrypted traffic categorization model (Block 419). The encrypted traffic categorization model can then be forwarded to the online system for use in operation of identifying encrypted data traffic.

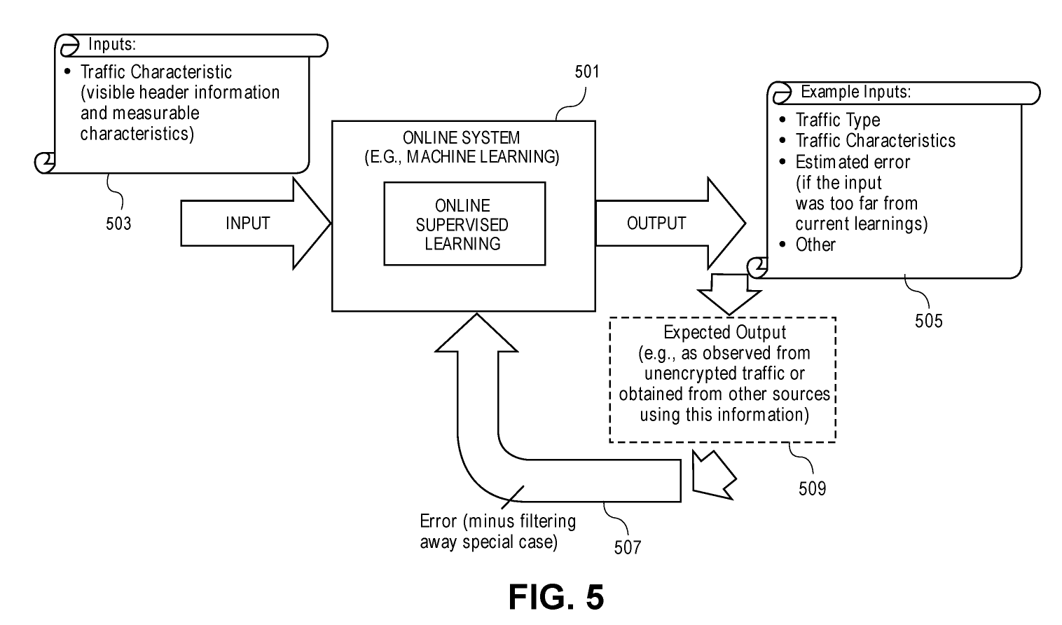

FIG. 5 is a diagram of one embodiment of the online system process. The process may correspond to phases [b-c-d] of FIG. 2. The process of the online system involves processing encrypted data traffic as it arrives at a first network device implementing online system process (e.g. a middle box implementing traffic management using DPI) that needs to use classification information for various network management purposes. The process first goes through online system process of FIG. 5. The online system utilizes the encrypted traffic categorization model, as mentioned previously, that may be provided by the training system or may be pre-fed with basic matching rules from the network operator or similar source. If online system can determine the application type and classify the data traffic flow as required (e.g. with given precision), then nothing else is done, the network node will continue with traffic management actions, e.g., in the case where the data traffic is unencrypted or the encryption has a visible identifier. In one embodiment, the precision of classification a measurement of how far the data is from data utilized in training the encrypted traffic categorization model. In other embodiments, the precision may be input from an external source (e.g., precision information may be input where another network node or traffic engineering function provides feedback about the effect of classification on the encrypted data traffic). However, if online system estimated the error to be high (e.g., Step[c]: no), then the process will trigger the anomaly injection mechanism (e.g., of Step [d]). If an anomaly is injected on the traffic flow and the encrypted traffic categorization models generated by the training system may be used to map the new traffic flow characteristics with an application type based on the behavior observed after anomaly injection.

In some embodiments, the online system takes the following input into its process, which can include ML processes. The inputs may include the traffic characteristics of the received data traffic including L0-L4 header information, throughput, packet size, packet inter-arrival time, and similar information (503). The output of this process can be a categorization of the received data traffic (505), for example an identification of a traffic type such as a voice call (e.g., VoLTE, Skype, Whatsapp call, Viber call), video call (e.g., FaceTime, Skype, Whatsapp call, Viber call), video streaming (e.g., Netflix, Hulu, Amazon), web browsing traffic (e.g., by browser type), file download, and similar traffic or application type. Additional output can include traffic characteristics, where the traffic characteristics may be other than those measurable (e.g., application parameters hidden by encryption and similar characteristics), estimate error (e.g., the estimated error on the output (to be used by Step [c]), or other traffic categorization information such as other statistical information that could be application specific and used for other means. In addition, the process may be fed back information on errors (507) after filtering out special cases such as non-representation cases. The output categorization can be compared to expected output to verify accuracy or for similar purposes (509).

Further processing can include checking if the encrypted traffic categorization models could identify the traffic type based on its behavior to the network anomaly that was injected. If not (i.e. where step [e]: no), then the data traffic flow and associated information is sent to Step [a] to trigger the offline process of retraining by the training system (e.g., by human operator or an automated process).

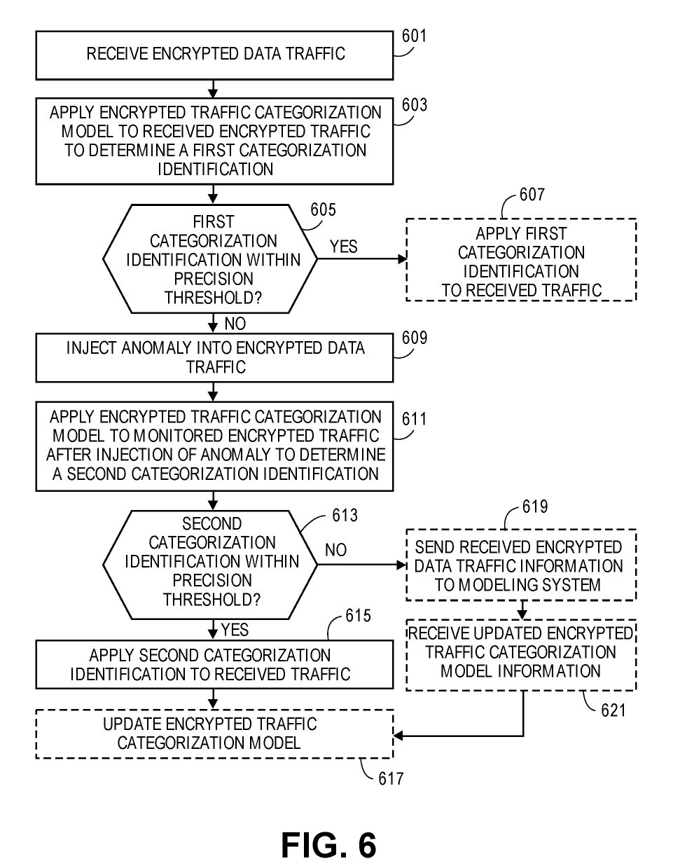

FIG. 6 is a flowchart of one embodiment of the process implemented by the online system. The representation of the process is provided by way of example rather than limitation. The process is applied as encrypted data traffic is received at the online system (Block 601). The encrypted traffic categorization model is applied using the basic traffic characteristics to generate a first categorization identification (Block 603). A check is then made whether the first categorization identification is within a precision threshold x (Block 605). As mentioned above, the precision can be a measurement of differences from training data, an external input or similar precision measure. If the categorization is within the precision threshold, then the categorization is utilized and the process completes (Block 607).

If the first categorization identification is not within a precision threshold, then the process injects a set of anomalies into the encrypted data traffic (Block 609). The encrypted data traffic with the anomalies is then monitored and then a second categorization identification is made based on the encrypted traffic categorization model (Block 611). A check is made whether the second categorization identification is within a precision threshold y (Block 613). If the second categorization identification is within the precision threshold, then this categorization is applied for traffic management purposes (Block 615). If the categorization can be utilized to update the encrypted traffic categorization model, then the encrypted traffic categorization model is updated before the process completes (Block 617). If the categorization is not within the precision threshold, then the encrypted data traffic information can be provided to the training system to update the encrypted traffic categorization model and improve the categorization precision (Step [e]:no) (Block 619). Once the training system has further processed the traffic information, then an updated encrypted traffic categorization model may be returned for use in the online system (Block 621).

The embodiments have advantages over the prior art. The processes of the embodiments are not performance hindering since the network anomaly injection can be controlled such that it does not cause service performance deterioration for end users. During training most of the test traffic is generated with fake end points or collected traces. Moreover, for live production traffic, anomaly injection is required only when the characteristics of the encrypted data traffic flow does not map to past learnings. Therefore, not all data traffic is constantly subject to network anomaly injection. Further, the embodiments minimize the problem of a malicious end point. Obfuscation (hiding or disguising information to prevent detection) can be limited to cases where the application changes its behavior constantly to prevent the processes from learning the data traffic behavior. This is considered as a rare case, and if the same application switches between a few known behavior models, a well-defined machine learning system should be able to learn them all. For encrypted data flows of very short duration that could not be identified by online system, the process can redirect the traffic information to the training system. This may require capture of much of the data flow as if there is too much delay then the training system may not have enough time because the flow does not exist anymore.

Architecture

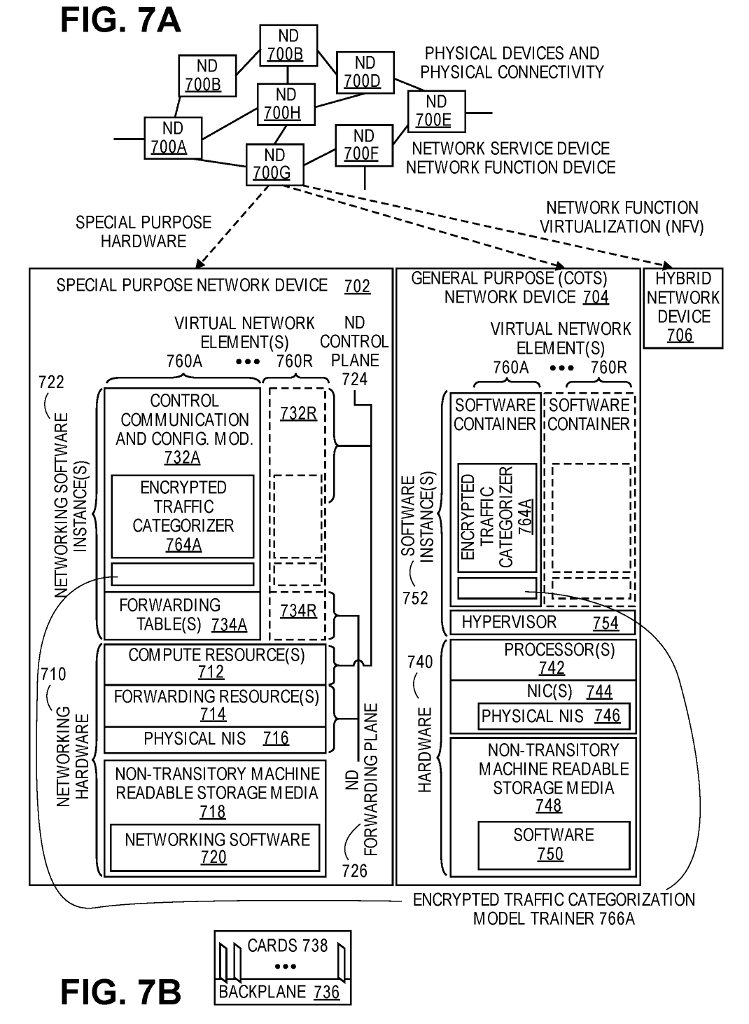

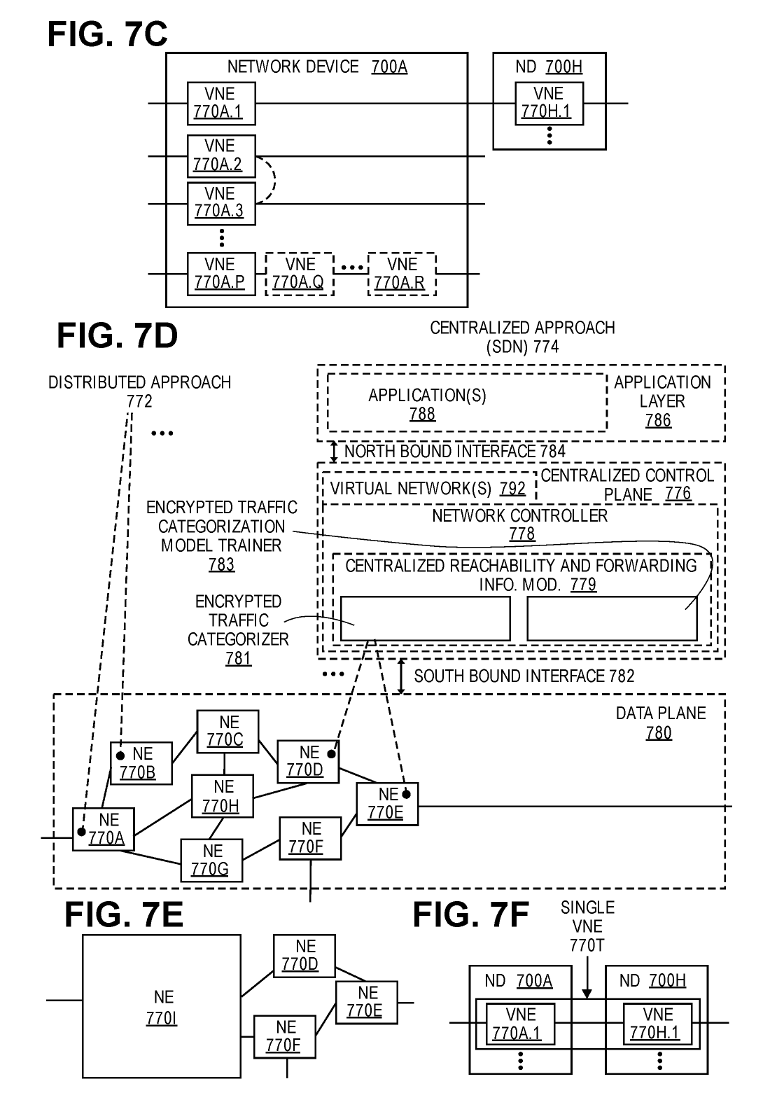

FIG. 7A illustrates connectivity between network devices (NDs) within an exemplary network, as well as three exemplary implementations of the NDs, according to some embodiments of the invention. FIG. 7A shows NDs 700A-H, and their connectivity by way of lines between 700A-700B, 700B-700C, 700C-700D, 700D-700E, 700E-700F, 700F-700G, and 700A-700G, as well as between 700H and each of 700A, 700C, 700D, and 700G. These NDs are physical devices, and the connectivity between these NDs can be wireless or wired (often referred to as a link). An additional line extending from NDs 700A, 700E, and 700F illustrates that these NDs act as ingress and egress points for the network (and thus, these NDs are sometimes referred to as edge NDs; while the other NDs may be called core NDs).

Two of the exemplary ND implementations in FIG. 7A are: 1) a special-purpose network device 702 that uses custom application-specific integrated-circuits (ASICs) and a special-purpose operating system (OS); and 2) a general purpose network device 704 that uses common off-the-shelf (COTS) processors and a standard OS.

The special-purpose network device 702 includes networking hardware 710 comprising compute resource(s) 712 (which typically include a set of one or more processors), forwarding resource(s) 714 (which typically include one or more ASICs and/or network processors), and physical network interfaces (NIs) 716 (sometimes called physical ports), as well as non-transitory machine readable storage media 718 having stored therein networking software 720. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 700A-H. During operation, the networking software 720 may be executed by the networking hardware 710 to instantiate a set of one or more networking software instance(s) 722. Each of the networking software instance(s) 722, and that part of the networking hardware 710 that executes that network software instance (be it hardware dedicated to that networking software instance and/or time slices of hardware temporally shared by that networking software instance with others of the networking software instance(s) 722), form a separate virtual network element 730A-R. Each of the virtual network element(s) (VNEs) 730A-R includes a control communication and configuration module 732A-R (sometimes referred to as a local control module or control communication module) and forwarding table(s) 734A-R, such that a given virtual network element (e.g., 730A) includes the control communication and configuration module (e.g., 732A), a set of one or more forwarding table(s) (e.g., 734A), and that portion of the networking hardware 710 that executes the virtual network element (e.g., 730A).

The special-purpose network device 702 is often physically and/or logically considered to include: 1) a ND control plane 724 (sometimes referred to as a control plane) comprising the compute resource(s) 712 that execute the control communication and configuration module(s) 732A-R; and 2) a ND forwarding plane 726 (sometimes referred to as a forwarding plane, a data plane, or a media plane) comprising the forwarding resource(s) 714 that utilize the forwarding table(s) 734A-R and the physical NIs 716. By way of example, where the ND is a router (or is implementing routing functionality), the ND control plane 724 (the compute resource(s) 712 executing the control communication and configuration module(s) 732A-R) is typically responsible for participating in controlling how data (e.g., packets) is to be routed (e.g., the next hop for the data and the outgoing physical NI for that data) and storing that routing information in the forwarding table(s) 734A-R, and the ND forwarding plane 726 is responsible for receiving that data on the physical NIs 716 and forwarding that data out the appropriate ones of the physical NIs 716 based on the forwarding table(s) 734A-R.

FIG. 7B illustrates an exemplary way to implement the special-purpose network device 702 according to some embodiments of the invention. FIG. 7B shows a special-purpose network device including cards 738 (typically hot pluggable). While in some embodiments the cards 738 are of two types (one or more that operate as the ND forwarding plane 726 (sometimes called line cards), and one or more that operate to implement the ND control plane 724 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 736 (e.g., a first full mesh coupling the line cards and a second full mesh coupling all of the cards).

Returning to FIG. 7A, the general purpose network device 704 includes hardware 740 comprising a set of one or more processor(s) 742 (which are often COTS processors) and network interface controller(s) 744 (NICs; also known as network interface cards) (which include physical NIs 746), as well as non-transitory machine readable storage media 748 having stored therein software 750. During operation, the processor(s) 742 execute the software 750 to instantiate one or more sets of one or more applications 764A-R and 766A-R. These applications may include an encrypted traffic categorizer 764A-R that implements the functions of the online system described herein above and/or an encrypted traffic categorization model trainer 766A-R that implements the functions of the training system described herein above. While one embodiment does not implement virtualization, alternative embodiments may use different forms of virtualization. For example, in one such alternative embodiment the virtualization layer 754 represents the kernel of an operating system (or a shim executing on a base operating system) that allows for the creation of multiple instances 762A-R called software containers that may each be used to execute one (or more) of the sets of applications 764A-R and 766A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 754 represents a hypervisor (sometimes referred to as a virtual machine monitor (VMM)) or a hypervisor executing on top of a host operating system, and each of the sets of applications 764A-R and 766A-R is run on top of a guest operating system within an instance 762A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 740, directly on a hypervisor (in which case the unikernel is sometimes described as running within a LibOS virtual machine), or in a software container, embodiments can be implemented fully with unikernels running directly on a hypervisor represented by virtualization layer 754, unikernels running within software containers represented by instances 762A-R, or as a combination of unikernels and the above-described techniques (e.g., unikernels and virtual machines both run directly on a hypervisor, unikernels and sets of applications that are run in different software containers).

The instantiation of the one or more sets of one or more applications 764A-R and 766A-R, as well as virtualization if implemented, are collectively referred to as software instance(s) 752. Each set of applications 764A-R and 766A-R, corresponding virtualization construct (e.g., instance 762A-R) if implemented, and that part of the hardware 740 that executes them (be it hardware dedicated to that execution and/or time slices of hardware temporally shared), forms a separate virtual network element(s) 760A-R.

The virtual network element(s) 760A-R perform similar functionality to the virtual network element(s) 730A-R—e.g., similar to the control communication and configuration module(s) 732A and forwarding table(s) 734A (this virtualization of the hardware 740 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 762A-R corresponding to one VNE 760A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 762A-R to VNEs also apply to embodiments where such a finer level of granularity and/or unikernels are used.

In certain embodiments, the virtualization layer 754 includes a virtual switch that provides similar forwarding services as a physical Ethernet switch. Specifically, this virtual switch forwards traffic between instances 762A-R and the NIC(s) 744, as well as optionally between the instances 762A-R; in addition, this virtual switch may enforce network isolation between the VNEs 760A-R that by policy are not permitted to communicate with each other (e.g., by honoring virtual local area networks (VLANs)).

The third exemplary ND implementation in FIG. 7A is a hybrid network device 706, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 702) could provide for para-virtualization to the networking hardware present in the hybrid network device 706.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 730A-R, VNEs 760A-R, and those in the hybrid network device 706) receives data on the physical NIs (e.g., 716, 746) and forwards that data out the appropriate ones of the physical NIs (e.g., 716, 746). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 7C illustrates various exemplary ways in which VNEs may be coupled according to some embodiments of the invention. FIG. 7C shows VNEs 770A.1-770A.P (and optionally VNEs 770A.Q-770A.R) implemented in ND 700A and VNE 770H.1 in ND 700H. In FIG. 7C, VNEs 770A.1-P are separate from each other in the sense that they can receive packets from outside ND 700A and forward packets outside of ND 700A; VNE 770A.1 is coupled with VNE 770H.1, and thus they communicate packets between their respective NDs; VNE 770A.2-770A.3 may optionally forward packets between themselves without forwarding them outside of the ND 700A; and VNE 770A.P may optionally be the first in a chain of VNEs that includes VNE 770A.Q followed by VNE 770A.R (this is sometimes referred to as dynamic service chaining, where each of the VNEs in the series of VNEs provides a different service—e.g., one or more layer 4-7 network services). While FIG. 7C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 7A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 7A may also host one or more such servers (e.g., in the case of the general purpose network device 704, one or more of the software instances 762A-R may operate as servers; the same would be true for the hybrid network device 706; in the case of the special-purpose network device 702, one or more such servers could also be run on a virtualization layer executed by the compute resource(s) 712); in which case the servers are said to be co-located with the VNEs of that ND.

A virtual network is a logical abstraction of a physical network (such as that in FIG. 7A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 7D illustrates a network with a single network element on each of the NDs of FIG. 7A, and within this straight forward approach contrasts a traditional distributed approach (commonly used by traditional routers) with a centralized approach for maintaining reachability and forwarding information (also called network control), according to some embodiments of the invention. Specifically, FIG. 7D illustrates network elements (NEs) 770A-H with the same connectivity as the NDs 700A-H of FIG. 7A.

FIG. 7D illustrates that the distributed approach 772 distributes responsibility for generating the reachability and forwarding information across the NEs 770A-H; in other words, the process of neighbor discovery and topology discovery is distributed.

For example, where the special-purpose network device 702 is used, the control communication and configuration module(s) 732A-R of the ND control plane 724 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 770A-H (e.g., the compute resource(s) 712 executing the control communication and configuration module(s) 732A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 724. The ND control plane 724 programs the ND forwarding plane 726 with information (e.g., adjacency and route information) based on the routing structure(s). For example, the ND control plane 724 programs the adjacency and route information into one or more forwarding table(s) 734A-R (e.g., Forwarding Information Base (FIB), Label Forwarding Information Base (LFIB), and one or more adjacency structures) on the ND forwarding plane 726. For layer 2 forwarding, the ND can store one or more bridging tables that are used to forward data based on the layer 2 information in that data. While the above example uses the special-purpose network device 702, the same distributed approach 772 can be implemented on the general purpose network device 704 and the hybrid network device 706.

FIG. 7D illustrates that a centralized approach 774 (also known as software defined networking (SDN)) that decouples the system that makes decisions about where traffic is sent from the underlying systems that forwards traffic to the selected destination. The illustrated centralized approach 774 has the responsibility for the generation of reachability and forwarding information in a centralized control plane 776 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 776 has a south bound interface 782 with a data plane 780 (sometime referred to the infrastructure layer, network forwarding plane, or forwarding plane (which should not be confused with a ND forwarding plane)) that includes the NEs 770A-H (sometimes referred to as switches, forwarding elements, data plane elements, or nodes). The centralized control plane 776 includes a network controller 778, which includes a centralized reachability and forwarding information module 779 that determines the reachability within the network and distributes the forwarding information to the NEs 770A-H of the data plane 780 over the south bound interface 782 (which may use the OpenFlow protocol). Thus, the network intelligence is centralized in the centralized control plane 776 executing on electronic devices that are typically separate from the NDs.

For example, where the special-purpose network device 702 is used in the data plane 780, each of the control communication and configuration module(s) 732A-R of the ND control plane 724 typically include a control agent that provides the VNE side of the south bound interface 782. In this case, the ND control plane 724 (the compute resource(s) 712 executing the control communication and configuration module(s) 732A-R) performs its responsibility for participating in controlling how data (e.g., packets) is to be routed (e.g., the next hop for the data and the outgoing physical NI for that data) through the control agent communicating with the centralized control plane 776 to receive the forwarding information (and in some cases, the reachability information) from the centralized reachability and forwarding information module 779 (it should be understood that in some embodiments of the invention, the control communication and configuration module(s) 732A-R, in addition to communicating with the centralized control plane 776, may also play some role in determining reachability and/or calculating forwarding information—albeit less so than in the case of a distributed approach; such embodiments are generally considered to fall under the centralized approach 774, but may also be considered a hybrid approach).

While the above example uses the special-purpose network device 702, the same centralized approach 774 can be implemented with the general purpose network device 704 (e.g., each of the VNE 760A-R performs its responsibility for controlling how data (e.g., packets) is to be routed (e.g., the next hop for the data and the outgoing physical NI for that data) by communicating with the centralized control plane 776 to receive the forwarding information (and in some cases, the reachability information) from the centralized reachability and forwarding information module 779; it should be understood that in some embodiments of the invention, the VNEs 760A-R, in addition to communicating with the centralized control plane 776, may also play some role in determining reachability and/or calculating forwarding information—albeit less so than in the case of a distributed approach) and the hybrid network device 706. In fact, the use of SDN techniques can enhance the NFV techniques typically used in the general purpose network device 704 or hybrid network device 706 implementations as NFV is able to support SDN by providing an infrastructure upon which the SDN software can be run, and NFV and SDN both aim to make use of commodity server hardware and physical switches.

FIG. 7D also shows that the centralized control plane 776 has a north bound interface 784 to an application layer 786, in which resides application(s) 788. The centralized control plane 776 has the ability to form virtual networks 792 (sometimes referred to as a logical forwarding plane, network services, or overlay networks (with the NEs 770A-H of the data plane 780 being the underlay network)) for the application(s) 788. Thus, the centralized control plane 776 maintains a global view of all NDs and configured NEs/VNEs, and it maps the virtual networks to the underlying NDs efficiently (including maintaining these mappings as the physical network changes either through hardware (ND, link, or ND component) failure, addition, or removal). The application(s) 788 can in some embodiments include the encrypted traffic categorizer 781 and/or the encrypted traffic categorization model trainer 783. In other embodiments, these components may be implemented in the centralized control plane 776.

While FIG. 7D shows the distributed approach 772 separate from the centralized approach 774, the effort of network control may be distributed differently or the two combined in certain embodiments of the invention. For example: 1) embodiments may generally use the centralized approach (SDN) 774, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 774, but may also be considered a hybrid approach.

While FIG. 7D illustrates the simple case where each of the NDs 700A-H implements a single NE 770A-H, it should be understood that the network control approaches described with reference to FIG. 7D also work for networks where one or more of the NDs 700A-H implement multiple VNEs (e.g., VNEs 730A-R, VNEs 760A-R, those in the hybrid network device 706). Alternatively or in addition, the network controller 778 may also emulate the implementation of multiple VNEs in a single ND. Specifically, instead of (or in addition to) implementing multiple VNEs in a single ND, the network controller 778 may present the implementation of a VNE/NE in a single ND as multiple VNEs in the virtual networks 792 (all in the same one of the virtual network(s) 792, each in different ones of the virtual network(s) 792, or some combination). For example, the network controller 778 may cause an ND to implement a single VNE (a NE) in the underlay network, and then logically divide up the resources of that NE within the centralized control plane 776 to present different VNEs in the virtual network(s) 792 (where these different VNEs in the overlay networks are sharing the resources of the single VNE/NE implementation on the ND in the underlay network).

On the other hand, FIGS. 7E and 7F respectively illustrate exemplary abstractions of NEs and VNEs that the network controller 778 may present as part of different ones of the virtual networks 792. FIG. 7E illustrates the simple case of where each of the NDs 700A-H implements a single NE 770A-H (see FIG. 7D), but the centralized control plane 776 has abstracted multiple of the NEs in different NDs (the NEs 770A-C and G-H) into (to represent) a single NE 770I in one of the virtual network(s) 792 of FIG. 7D, according to some embodiments of the invention. FIG. 7E shows that in this virtual network, the NE 770I is coupled to NE 770D and 770F, which are both still coupled to NE 770E.

FIG. 7F illustrates a case where multiple VNEs (VNE 770A.1 and VNE 770H.1) are implemented on different NDs (ND 700A and ND 700H) and are coupled to each other, and where the centralized control plane 776 has abstracted these multiple VNEs such that they appear as a single VNE 770T within one of the virtual networks 792 of FIG. 7D, according to some embodiments of the invention. Thus, the abstraction of a NE or VNE can span multiple NDs.

While some embodiments of the invention implement the centralized control plane 776 as a single entity (e.g., a single instance of software running on a single electronic device), alternative embodiments may spread the functionality across multiple entities for redundancy and/or scalability purposes (e.g., multiple instances of software running on different electronic devices).

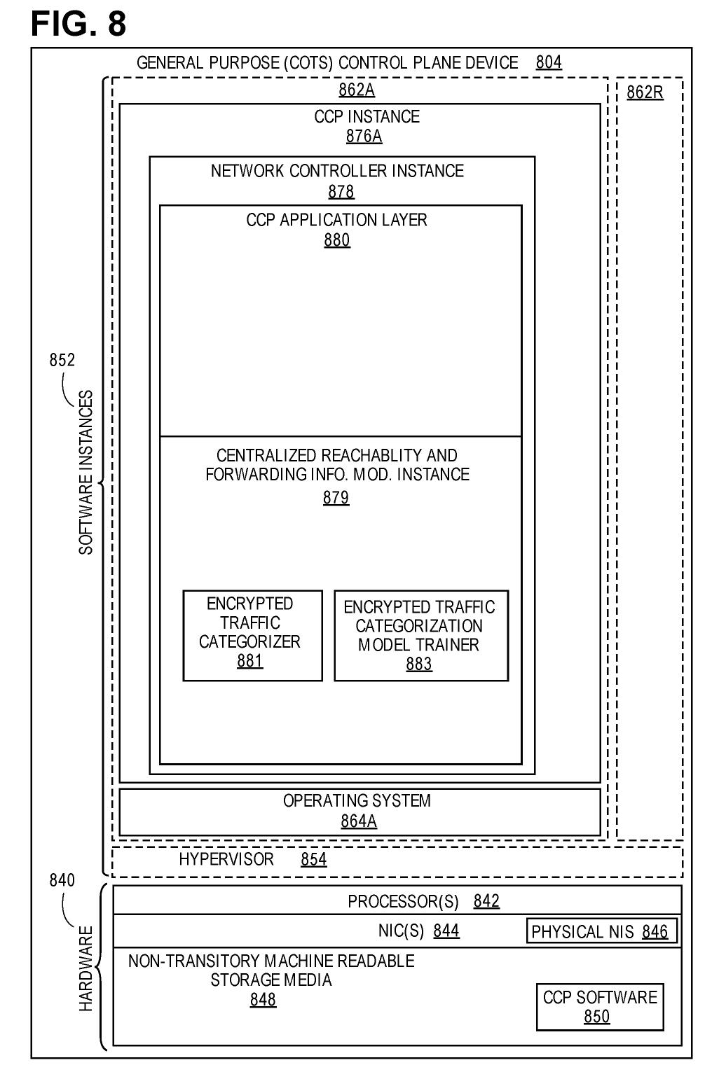

Similar to the network device implementations, the electronic device(s) running the centralized control plane 776, and thus the network controller 778 including the centralized reachability and forwarding information module 779, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 8 illustrates, a general purpose control plane device 804 including hardware 840 comprising a set of one or more processor(s) 842 (which are often COTS processors) and network interface controller(s) 844 (NICs; also known as network interface cards) (which include physical NIs 846), as well as non-transitory machine readable storage media 848 having stored therein centralized control plane (CCP) software 850.

In embodiments that use compute virtualization, the processor(s) 842 typically execute software to instantiate a virtualization layer 854 (e.g., in one embodiment the virtualization layer 854 represents the kernel of an operating system (or a shim executing on a base operating system) that allows for the creation of multiple instances 862A-R called software containers (representing separate user spaces and also called virtualization engines, virtual private servers, or jails) that may each be used to execute a set of one or more applications; in another embodiment the virtualization layer 854 represents a hypervisor (sometimes referred to as a virtual machine monitor (VMM)) or a hypervisor executing on top of a host operating system, and an application is run on top of a guest operating system within an instance 862A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 840, directly on a hypervisor represented by virtualization layer 854 (in which case the unikernel is sometimes described as running within a LibOS virtual machine), or in a software container represented by one of instances 862A-R). Again, in embodiments where compute virtualization is used, during operation an instance of the CCP software 850 (illustrated as CCP instance 876A) is executed (e.g., within the instance 862A) on the virtualization layer 854. In embodiments where compute virtualization is not used, the CCP instance 876A is executed, as a unikernel or on top of a host operating system, on the “bare metal” general purpose control plane device 804. The instantiation of the CCP instance 876A, as well as the virtualization layer 854 and instances 862A-R if implemented, are collectively referred to as software instance(s) 852.

In some embodiments, the CCP instance 876A includes a network controller instance 878. The network controller instance 878 includes a centralized reachability and forwarding information module instance 879 (which is a middleware layer providing the context of the network controller 778 to the operating system and communicating with the various NEs), and an CCP application layer 880 (sometimes referred to as an application layer) over the middleware layer (providing the intelligence required for various network operations such as protocols, network situational awareness, and user-interfaces). At a more abstract level, this CCP application layer 880 within the centralized control plane 776 works with virtual network view(s) (logical view(s) of the network) and the middleware layer provides the conversion from the virtual networks to the physical view. Applications can in some embodiments be executed by the network controller instance in the CCP application layer 880 or in a similar manner. The applications can include the encrypted traffic categorizer 881 and/or the encrypted traffic categorization model trainer 883. In other embodiments, these components may be implemented in the centralized control plane 876.

The centralized control plane 776 transmits relevant messages to the data plane 780 based on CCP application layer 880 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 780 may receive different messages, and thus different forwarding information. The data plane 780 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 780, the packet (or a subset of the packet header and content) is typically forwarded to the centralized control plane 776. The centralized control plane 776 will then program forwarding table entries into the data plane 780 to accommodate packets belonging to the flow of the unknown packet. Once a specific forwarding table entry has been programmed into the data plane 780 by the centralized control plane 776, the next packet with matching credentials will match that forwarding table entry and take the set of actions associated with that matched entry.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method implemented by a network device to classify encrypted data traffic, the method to identify characteristics of the encrypted data traffic that have been modeled where network anomalies have been injected into the encrypted data traffic to provide additional traffic characteristics that enable categorization, the method comprising:
receiving the encrypted data traffic;
applying an encrypted traffic categorization model to the received encrypted data traffic to determine a first categorization identification;
injecting an anomaly into the encrypted data traffic where the first categorization identification is not within a precision threshold;
applying the encrypted traffic categorization model to monitored encrypted traffic after injection of the anomaly to determine a second categorization identification; and
applying the second categorization identification where the second categorization identification is within the precision threshold.

2. The method of claim 1, further comprising:
sending received encrypted data traffic information to a modeling system, in response to the second categorization identification not being within the precision threshold.

3. The method of claim 2, further comprising:
receiving an updated encrypted traffic categorization model information from a training system; and
updating the encrypted traffic categorization model.

4. The method of claim 1, further comprising:
generating a set of test traffic of known types;
measuring traffic characteristics of the set of test traffic; and
injecting an anomaly into a test network with the set of test traffic.

5. The method of claim 4, further comprising:
measuring traffic characteristics of the set of test traffic and anomaly; and
training the encrypted traffic categorization model with the measured traffic characteristics.

6. A network device configured to execute a method to classify encrypted data traffic, the method to identify characteristics of the encrypted data traffic that have been modeled where network anomalies have been injected into the encrypted data traffic to provide additional traffic characteristics that enable categorization, the network device comprising:
a non-transitory computer-readable storage medium having stored therein an encrypted traffic categorizer; and
a processor coupled to the non-transitory computer-readable storage medium, the processor configured to execute the encrypted traffic categorizer, the encrypted traffic categorizer to receive the encrypted data traffic, to apply an encrypted traffic categorization model to the received encrypted data traffic to determine a first categorization identification, to inject an anomaly into the encrypted data traffic where the first categorization identification is not within a precision threshold, to apply the encrypted traffic categorization model to monitored encrypted traffic after injection of the anomaly to determine a second categorization identification, and to apply the second categorization identification where the second categorization identification is within the precision threshold.

7. The network device of claim 6, wherein the encrypted traffic categorizer further to send received encrypted data traffic information to a modeling system, in response to the second categorization identification not being within the precision threshold.

8. The network device of claim 7, wherein the encrypted traffic categorizer further to receive an updated encrypted traffic categorization model information from a training system, and update the encrypted traffic categorization model.

9. The network device of claim 6, wherein the non-transitory computer readable medium further storing an encrypted traffic categorization model trainer, which when executed by the processor generates a set of test traffic of known types, measures traffic characteristics of the set of test traffic, and injects an anomaly into a test network with the set of test traffic.

10. The network device of claim 9, wherein the encrypted traffic categorization model trainer is further to measure traffic characteristics of the set of test traffic and anomaly, and to train the encrypted traffic categorization model with the measured traffic characteristics.

11. A computing device executing a plurality of virtual machines for implementing network function virtualization (NFV), wherein a virtual machine from the plurality of virtual machines is configured to execute a method to classify encrypted data traffic, the method to identify characteristics of the encrypted data traffic that have been modeled where network anomalies have been injected into the encrypted data traffic to provide additional traffic characteristics that enable categorization, the computing device comprising:
a non-transitory computer-readable storage medium having stored therein an encrypted traffic categorizer; and
a processor coupled to the non-transitory computer-readable storage medium, the processor configured to execute one of the plurality of virtual machine, the virtual machine to execute the encrypted traffic categorizer, the encrypted traffic categorizer to receive the encrypted data traffic, to apply an encrypted traffic categorization model to the received encrypted data traffic to determine a first categorization identification, to inject an anomaly into the encrypted data traffic where the first categorization identification is not within a precision threshold, to apply the encrypted traffic categorization model to monitored encrypted traffic after injection of the anomaly to determine a second categorization identification, and to apply the second categorization identification where the second categorization identification is within the precision threshold.

12. The computing device of claim 11, wherein the encrypted traffic categorizer further to send received encrypted data traffic information to a modeling system, in response to the second categorization identification not being within the precision threshold.

13. The computing device of claim 12, wherein the encrypted traffic categorizer further to receive an updated encrypted traffic categorization model information from a training system, and update the encrypted traffic categorization model.

14. The computing device of claim 11 wherein the non-transitory computer-readable medium further storing an encrypted traffic categorization model trainer, which when executed by the virtual machine generates a set of test traffic of known types, measures traffic characteristics of set of test traffic, and injects an anomaly into a test network with the set of test traffic.

15. The network device of claim 14, wherein the encrypted traffic categorization model trainer is further to measure traffic characteristics of the set of test traffic and anomaly, and to train the encrypted traffic categorization model with the measured traffic characteristics.

16. A control plane device configured to implement at least one centralized control plane for a software defined network (SDN), the centralized control plane configured to execute method to classify encrypted data traffic, the method to identify characteristics of the encrypted data traffic that have been modeled where network anomalies have been injected into the encrypted data traffic to provide additional traffic characteristics that enable categorization, the control plane device comprising:
a non-transitory computer-readable storage medium having stored therein an encrypted traffic categorizer; and
a processor coupled to the non-transitory computer-readable storage medium, the processor configured to execute the encrypted traffic categorizer, the encrypted traffic categorizer to receive the encrypted data traffic, to apply an encrypted traffic categorization model to the received encrypted data traffic to determine a first categorization identification, to inject an anomaly into the encrypted data traffic where the first categorization identification is not within a precision threshold, to apply the encrypted traffic categorization model to monitored encrypted traffic after injection of the anomaly to determine a second categorization identification, and to apply the second categorization identification where the second categorization identification is within the precision threshold.

17. The control plane device of claim 16, wherein the encrypted traffic categorizer further to send received encrypted data traffic information to a modeling system, in response to the second categorization identification not being within the precision threshold.

18. The control plane device of claim 17, wherein the encrypted traffic categorizer further to receive an updated encrypted traffic categorization model information from a training system, and update the encrypted traffic categorization model.

19. The control plane device of claim 17 wherein the non-transitory computer readable medium further storing an encrypted traffic categorization model trainer, which when executed by the virtual machine generates a set of test traffic of known types, measures traffic characteristics of set of test traffic, and injects an anomaly into a test network with the set of test traffic.

20. The control plane device of claim 19, wherein the encrypted traffic categorization model trainer is further to measure traffic characteristics of the set of test traffic and anomaly, and to train the encrypted traffic categorization model with the measured traffic characteristics.
